(19) United States
(12) Patent Application Publication
(10) Pub. No.: US 2007/0143806 A1
(43) Pub. Date: Jun. 21, 2007

(54) Wireless system for television and data communications

(76) Inventor: Shaoher X. Pan, San Jose, CA (US)

Correspondence Address: Shaoher Pan;C/O Xin Wen, 3449 Rambow Drive, Palo Alto, CA, 94306, US

(21) Appl. No.: 11/311,033

(22) Filed: Dec. 17, 2005

(51) Int. Cl. H04N 7/18; H04N 7/173

(52) U.S. Cl. 725/111; 725/81

(57) ABSTRACT

A wireless system for data and video communications includes a hybrid modem configured to receive a digital data signal and an analog video data signal from one or more communication channels and convert the digital data signal and the video signal to RF digital data, and a wireless router configured to transmit wireless signals to one or more electronic devices in response to the RF digital data.

### BACKGROUND

This invention relates to a system for providing and receiving wireless video signals.

Home entertainment electronic devices have proliferated. A typical household contains multiple home entertainment electronic devices, such as televisions, compact disk players, DVD players, TIVO players, audio/video receivers, video cassette recorders (VCRs), set top boxes, and satellite receivers. Additionally, other types of home electronic devices are increasingly common, such as electronic refrigerators, ovens, video surveillance systems, alarm systems, baby monitoring systems and the like.

At the same time economical wireless and wired home networking capabilities are emerging. Types of wireless networks can include Bluetooth, IrDA, and Wi-Fi devices. Bluetooth operates around the 3.45 Ghz frequency band, and provides a standard for short distance wireless communications between electronic devices. IrDA (Infrared Data Association) is a standard for electronic devices to communicate using infrared light pulses. Wi-Fi devices are both based on the wireless Ethernet specification, known as IEEE 802.11. Wi-Fi originally was targeted more for office environments, and was developed by the Wireless Ethernet Compatibility Alliance (WECA). Wi-Fi is essentially a seal of approval that indicates a device is compatible with IEEE 802.11(b). Wi-Fi devices also support longer range communications ranging from 100 to more than 300 meters. Additionally, enhanced versions of these standards are being developed to more effectively support video signals. For example, the IEEE 802.11(a) with MAC enhancements for supporting video has been achieved in IEEE 802.11(e). Furthermore, an ultra-wide band wireless personal area networking standard, IEEE 802.15.3a that can support high data rates is emerging that can be used for supporting video signals.

Types of wired networks can include traditional wired networks using twisted copper pairs, coaxial cable or fiber optics. Additionally, wired networks can include emerging powerline networks. There are a number of competing power-line technologies, such as Passport, which was developed by Intelogis and a newer technology referred to PowerPacket, which was developed by Intellon. The PowerPacket technology has been recently selected by the HomePlug Alliance, an industry association, as the standard for power-line networking. Power line networks provide communication paths over existing electrical wiring within a house or office.

Typical televisions are directly tied to their source of information. The TV tube/display is packaged with the (Radio Frequency) RF tuner, which is wired to the antenna, cable, VCR, or satellite set-top box for a satellite dish system. Now, with Wi-Fi technology, more and more televisions will be able to be placed just about anywhere in the house, without the need for a wired antenna, cable, or satellite connection. Breaking these direct display connections and operating without wires effectively untethers the display from its information source. A user can watch TV in his/her home without having to run long cables thereby increasing the flexibility in display placement and the overall convenience. An untethered TV is sometimes referred to as portable TV or wireless TV.

FIG. 1 shows a typical wireless TV system 100. The wireless TV system 100 can receive television signals from a cable 110, a satellite dish 110, or a TV antenna. A cable set-top box 115 and a satellite set-top box 125 can be included to allow a user to tune channels or interact with the service provider for Pay-per-View TV programs. A TV display can be wire-connected to the cable set-top box 115 or the satellite set-top box 125 for viewing in the vicinity of the cable set-top box 115 and the satellite set-top box 125. A wireless TV tuner 140 (also referred as TV transmitter, TV sender, or TV Link) is connected to the cable set-top box 115 and the satellite set-top box 125. The wireless TV tuner 140 can transmit wireless television signals across a user's home through an antenna 145 to be received by multiple portable TVs or computers 170. Each portable TV or computer 170 is equipped with a wireless TV receiver 160 having an antenna 165 for receiving the wireless signals emitted from the wireless tuner 140. The antenna 145 and 165 can for example include internal dipole antenna. A remote control extender can be included in the wireless TV 100 to allow a user to remote control of the video source from any location in the house. Typical broadcast range for the wireless tuner 140 is between 15 meters and 30 meters indoor and 100 meters in the outdoor.

One shortcoming associated with the above wireless TV systems is in the requirement of dedicated wireless TV tuner and wireless TV receivers. These specialized equipments increase the costs and the footprint of the present wireless TV system.

FIG. 2 shows a digital wireless TV system 200 that receives digital video signals in data packets from computer network via cable 210 and cable modem 215, satellite system 220 via satellite modem 225, or telephone line 230 through a DSL modem 235. The video signals can be streamed or downloaded. The source signals are in digital data packets. A wireless router 260 equipped with an antenna 265 transmits the video signals to the vicinity. The wireless signals can be received by a portable display device 271 having an antenna 272 and wireless computer 277 having an antenna 278 and an adapter. An example of this type of digital wireless TV systems is RangeMax 240 available from by Netgear, a division of Cisco Systems, Inc., and Airgo, Inc. The data transfer rate in the air can reach 120 to 240 megabits per second. One drawback of the digital wires TV system is that it can only handle digital video signals in digital format that are carried in the computer networks. The vast majority video content in analog TV channels cannot be handled in this type of systems.

### SUMMARY OF THE INVENTION

In one aspect, the present invention relates to a wireless system for data and video communications, including: a hybrid modem configured to receive a digital data signal and an analog video data signal from one or more communication channels and convert the digital data signal and the video signal to RF digital data; and a wireless router configured to transmit wireless signals to one or more electronic devices in response to the RF digital data.

In another aspect, the present invention relates to a wireless system for data and video communications, including: a hybrid modem that includes a data modem configured to receive a digital data signal and convert digital data signal into a first RF digital data; and a TV modem configured to receive a video signal and convert video signal into a second RF digital data; and a wireless router configured to transmit wireless signals to one or more electronic devices in response to the first RF digital data or the second RF digital data.

In another aspect, the present invention relates to a wireless system for data and video communications, including: a hybrid modem that includes a data modem configured to receive a digital data signal and convert digital data signal into a first RF digital data; and a TV modem configured to receive a video signal carried in digital video data packets or in analog format and to convert the video signal into a second RF digital data; and a wireless router configured to transmit wireless signals to one or more electronic devices in response to the first RF digital data or the second RF digital data.

Implementations of the system may include one or more of the following. The hybrid modem can include a data modem configured to receive the digital data signal and a TV modem configured to receive the video signal. The TV modem can be configured to receive the video signal in video data packets and to extract video data from the video data packets. The TV modem can be configured to receive the video signal in analog format. The wireless router can include a RF transceiver configured to convert the video data and the digital data signal to an RF digital data. The wireless router can include an antenna configured to transmit a wireless signal to the one or more electronic devices in response to the RF digital data. The data modem and the TV modem can be fabricated on a single semiconductor chip. The wireless router can include an antenna configured to receive user selection information and the status information from the one or more of the electronic devices. The wireless router can include an antenna configured to transmit and receive wireless signals to communicate with the one or more electronic devices. The electronic devices can include one or more of a computer, a portable TV, a video recorder, a video player, and a cell phone. The communication channels can include one or more of a cable network, a satellite dish system, a telephone line, and a TV antenna. The wireless system can further include a set-top box configured to receive the digital data signal and the video data signal from one or more communication channels.

Embodiments may include one or more of the following advantages. The disclosed wireless system provides data and telephone communications in a local area in a shared wireless network platform, which does not require dedicated wireless TV tuner and wireless receivers in the present wireless TV system. A hybrid modem is provided to handle both digital data and the video data. The hybrid modem can be fabricated on a single semiconductor chip. The equipment cost and foot print can therefore be reduced comparing to the present wireless TV systems.

Another advantage of the invention wireless system is that it allows a user to view TV or video signals from both digital and analog sources. This capability allows the user to access a broad range of video and TV content.

Another advantage of the invention wireless system is that it provides two-way communications between a wireless TV and the video source to allow a user to remotely select TV channels and TV programs at the vicinity of the portable TV and computer.

Yet another advantage of the invention wireless system is that it allows a user to conveniently receive video signals in a local area such as a home without the need for installing long cables to different display locations in the local area. The invention system is applicable to homes, offices, classrooms, etc.

### BRIEF DESCRIPTION OF THE DRAWINGS

The following drawings, which are incorporated in and from a part of the specification, illustrate embodiments of the present invention and, together with the description, serve to explain the principles of the invention.

FIG. 1 is a schematic diagram of a conventional wireless TV system.

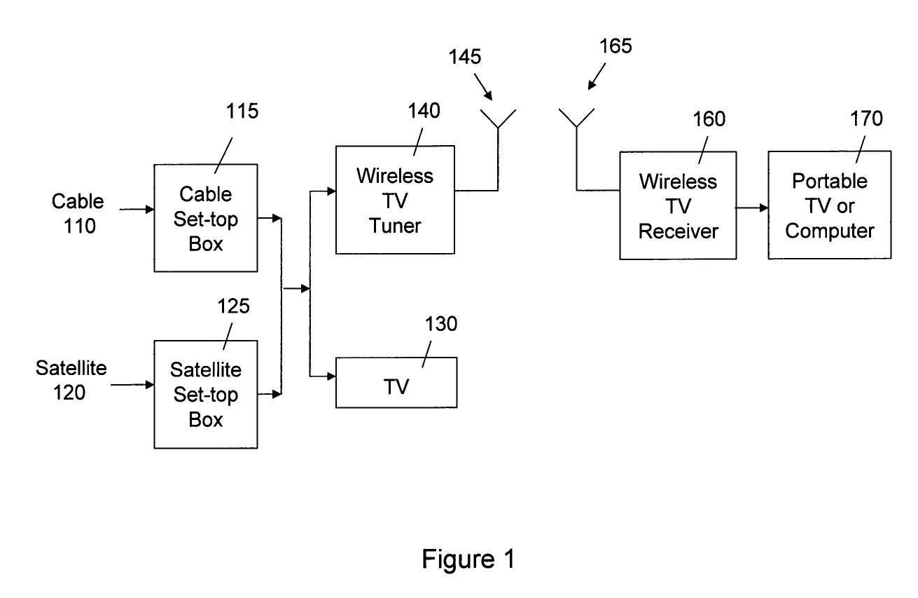

FIG. 2 is a schematic diagram for digital wireless TV system.

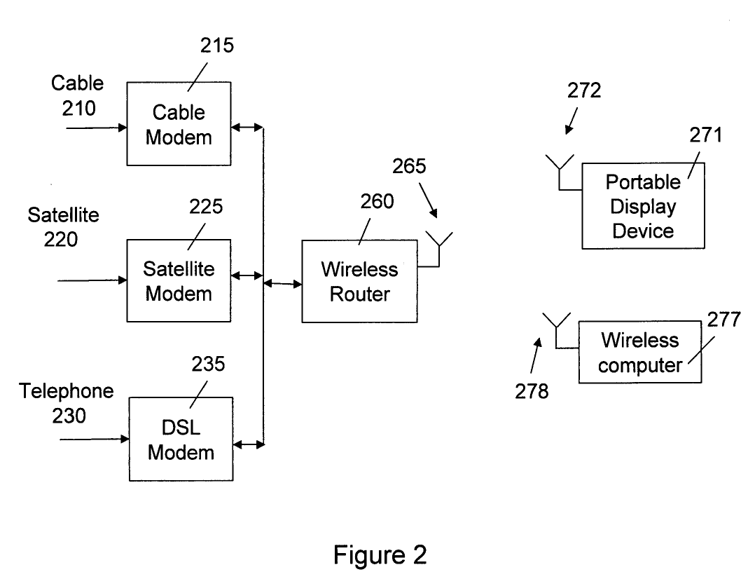

FIG. 3 shows a schematic diagram of a wireless system for data and video communications in accordance with the present invention.

### DESCRIPTION OF THE INVENTION

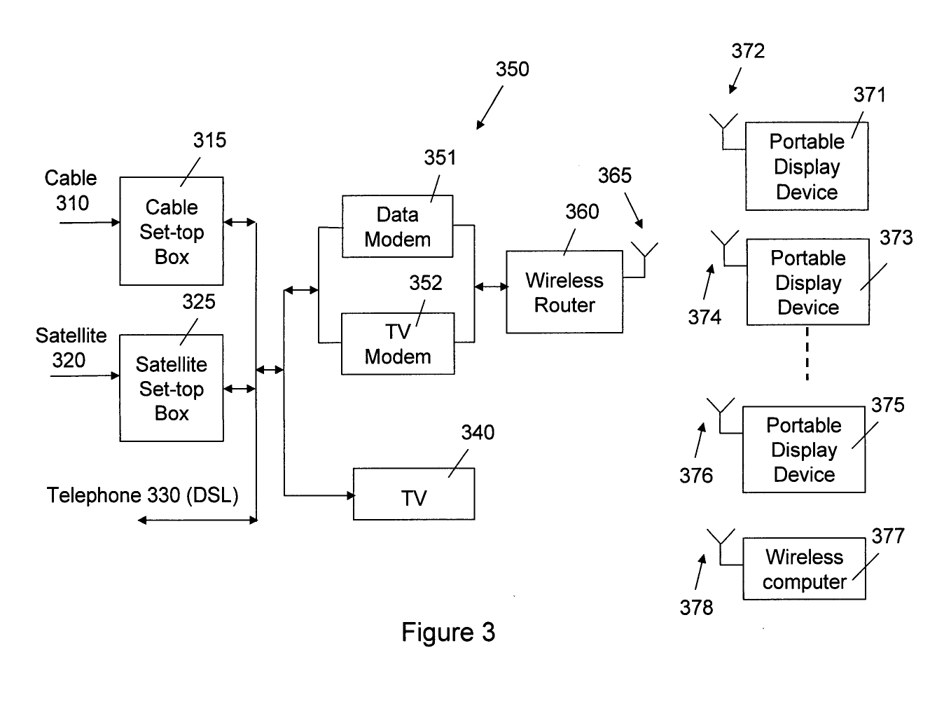

FIG. 3 is a schematic diagram of a wireless system 300 for data and video communications. The wireless system 300 can receive video data and digital data from a variety of digital broad band sources such as a cable 310, a satellite dish system 320, and a telephone line 330 (e.g. DSL). The digital signals provided by the cable 310, the satellite dish system 320, the telephone line 330 such as a DSL line allow a user to access the Internet, send or receive e-mailes, or share digital image files. The video signals can include Community Antenna Television (CATV) signals supplied by a cable television company through the cable 310 and an off-air broadcast television signals from a TV antenna. A cable set-top box 315 can be included to receive data and video signals from the cable network via cable 310. A satellite set-top box 325 can be included to receive data and video signals from the satellite dish system 320. A TV 340 can be wire-connected to the cable set-top box 315 or the satellite set-top box 320 for viewing in the vicinity of the source of the TV signal in a home.

In accordance with the present invention, the wireless system 300 includes a hybrid modem 350 for handling both digital data and video signal received from the cable 310, satellite 320, and telephone 330. The hybrid modem 350 comprises a data modem 351 and a TV modem 352. The data modem 351 handles the decoding of the digital data from the cable 310, the satellite 320, and the telephone 330. The video data are typically transmitted in data packets. The TV modem 352 receives the data packets for video signals from the cable 310, the satellite 320, and the telephone 330. A video data packet may define a header that uniquely identifies the video data with each packet. The video data is extracted from the video data packets and converted to digital data format. The digital data is subsequently up-converted by a RF transceiver to RF digital data suitable for wireless communication by a wireless router 360. The TV modem 352 can include a filter for filtering out commercial programs at the user's choice.

The TV modem 352 can automatically detect the digital video signals versus analog video signals. The TV modem 352 can also include an analog-to-digital converter for converting analog video signals to digital video signals. The analog video signals can be converted to digital video data packets and then up-converted by a RF transceiver to RF digital data to be wireless transmitted by wireless router 360 and antenna 365.

The hybrid modem 350 can also be connected with an electronic storage device for recording TV programs for a user to watch after the analog TV signals for TV programs are received from the cable 310 and the satellite dish system 320. The hybrid modem 350 together with the wireless router 360 form a base station or gateway for digital data or video communication within a local area such as a home.

An important feature of the hybrid modem 350 is that it can handle both digital and analog video signals. The digital video signals can be streamed or downloaded from a broadband computer network such as cable, satellite, DSL telephone, or optical fiber. The analog TV signals can be received from TV antenna, satellite, or a cable network. The TV modem 352 can automatically detect the digital video signals versus analog video signals. The capability to receive both digital and analog video source greatly broadens a user's access to video and TV content, which significantly lowers the barrier for the conversion from analog to digital video systems.

Typical formats for the wireless signals transmitted by the wireless router 360 can include but are not limited to IEEE 802.11(a), (b), (e), (g), and other Wi-Fi and Wi-Max standards and protocols. In particular, the wireless system 300 is capable of transmitting high data-rate for data and video applications. The wireless router 360 can be based on similar configurations as Wi-Fi wireless communication outers provided by companies such as Netgear, a division of Cisco Systems Corp. and Linksys, Inc., which are already used in many homes and offices.

The wireless signals are transmitted by an antenna 365 from the wireless router 360 and can be received by a plurality of portable electronic devices 371, 373, 375 and one or more wireless computers 377. The portable electronic device 371, 373, 375 can include TVs, computers, video players, video recorders, video enabled cell phones and portable digital assistants (PDAs). The wireless computer 377 includes a wireless card and antenna for receiving wireless signals. The wireless computer 377 can include laptops computer, desktop computers, or other types of computers. The wireless antenna and card can be built into the wireless computer 377 or installed as a plug-in card or a USB device. Each portable electronic device 371, 373, 375 can include a display for video watching. The portable electronic device 371, 373, 375 is equipped with an antenna 372, 374, and 376 and an RF transceiver and for converting wireless signals to digital data. The video signals received by the antenna 372, 374, and 376 can be converted by the RF transceiver to digital data, which can be subsequently converted to video data packets for displaying at the respective display devices. The wireless signals can be in radio frequencies in the range of 10 MHz to 100 GHz. A user can thus watch TV programs from the cable network or satellite on a portable electronic device anywhere within an area having good reception of the wireless signals.

Unlike the present wireless TV systems, the wireless communications between the wireless router 360 and the portable electronic devices 371, 373, 375 are bidirectional through an RF transceiver and an antenna 372, 374, and 376 in the portable electronic devices 371, 373, 375 and the RF transceiver and the antenna 365 in the wireless router 360. The wireless router 360, the data modem 351 and the TV modem 352 can also bi-directionally communicate with the sources of data and video signals from the cable 310, satellite 320, and the telephone lines 330. The capability of bidirectional communications allows a user to select TV channels and TV programs, to pay for a pay-per-view TV, or to download a digital video program for watching or playing at the portable electronic devices 371, 373, 375. In addition to the user selection information, the antenna 372, 374, and 376 can also send the status information of the one or more portable electronic devices to the antenna 365. The status of the portable electronic devices can include “power on”, “power off”, “sleep mode”, “programmed recording schedule”, and the makes and the model numbers of the display devices.

The sharing with existing wireless communication infrastructure already available at home and offices can significantly reduce cost and footprint, and improves the convenience for the users. Moreover, the cable receiver 315 and the satellite receiver 325 can be eliminated by integrating their functions into the hybrid modem 350 so such that hybrid modem can automatically detect the types of incoming signals, decode or demodulate the received digital data and video data.

In another embodiment, the hybrid modem 350 can be fabricated on a single chip over a semiconductor substrate. The hybrid modem 350 can automatically detect video and digital data format from the incoming signals for appropriate decoding operations. The use of single chip for the data modem 351 and the TV modem 352 further reduces the costs and allows miniaturization of the wireless system 300 comparing to the present wireless TV system.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A wireless system for data and video communications, comprising:
a hybrid modem configured to receive a digital data signal and an analog video data signal from one or more communication channels and convert the digital data signal and the video signal to RF digital data; and
a wireless router configured to transmit wireless signals to one or more electronic devices in response to the RF digital data.

2. The wireless system of claim 1, wherein the hybrid modem includes a data modem configured to receive the digital data signal and a TV modem configured to receive the video signal.

3. The wireless system of claim 2, wherein the TV modem is configured to receive the video signal in video data packets and to extract video data from the video data packets.

4. The wireless system of claim 2, wherein the TV modem is configured to receive the video signal in analog format.

5. The wireless system of claim 2, wherein the wireless router includes a RF transceiver configured to convert the video data and the digital data signal to an RF digital data.

6. The wireless system of claim 5, wherein the wireless router includes an antenna configured to transmit a wireless signal to the one or more electronic devices in response to the RF digital data.

7. The wireless system of claim 2, wherein the data modem and the TV modem are fabricated on a single semiconductor chip.

8. The wireless system of claim 1, wherein the wireless router includes an antenna configured to receive user selection information and the status information from the one or more of the electronic devices.

9. The wireless system of claim 1, wherein the wireless router includes an antenna configured to transmit and receive wireless signals to communicate with the one or more electronic devices.

10. The wireless system of claim 1, wherein the one or more electronic devices include one or more of a computer, a portable TV, a video recorder, a video player, and a cell phone.

11. The wireless system of claim 1, wherein the communication channels include one or more of a cable network, a satellite dish system, a telephone line, and a TV antenna.

12. The wireless system of claim 1, further comprising a set-top box configured to receive the digital data signal and the video data signal from one or more communication channels.

13. A wireless system for data and video communications, comprising:
a hybrid modem,
a) a data modem configured to receive a digital data signal and convert digital data signal into a first RF digital data; and
b) a TV modem configured to receive a video signal and convert video signal into a second RF digital data; and
a wireless router configured to transmit wireless signals to one or more electronic devices in response to the first RF digital data or the second RF digital data.

14. The wireless system of claim 13, wherein the TV modem is configured to receive the video signal in video data packets and to extract digital video data from the video data packets.

15. The wireless system of claim 14, wherein the wireless router includes a RF transceiver configured to convert the digital video data to the first RF digital data and the digital data signal to the second RF digital data.

16. The wireless system of claim 15, wherein the wireless router includes an antenna configured to transmit a wireless signal to the one or more electronic devices in response to the RF digital data.

17. The wireless system of claim 13, wherein the TV modem is configured to receive the video signal in analog format.

18. The wireless system of claim 13, wherein the data modem and the TV modem are fabricated on a single semiconductor chip.

19. The wireless system of claim 13, wherein the hybrid modem is configured to receive the digital data signal and the video data signal from one or more communication channels selected from the group of a cable network, a satellite dish system, a telephone line, and a TV antenna.

20. A wireless system for data and video communications, comprising:
a hybrid modem,
a) a data modem configured to receive a digital data signal and convert digital data signal into a first RF digital data; and
b) a TV modem configured to receive a video signal carried in digital video data packets or in analog format and to convert the video signal into a second RF digital data; and
a wireless router configured to transmit wireless signals to one or more electronic devices in response to the first RF digital data or the second RF digital data.
